(19) United States
(12) Patent Application Publication
(10) Pub. No.: US 2024/0222995 A1
(43) Pub. Date: Jul. 4, 2024

(54) CHARGING METHOD, DEVICE, CHARGING CIRCUIT, ELECTRONIC DEVICE, AND STORAGE MEDIUM

(71) Applicant: Lenovo (Beijing) Limited, Beijing (CN)

(72) Inventors: Huosheng LIAO, Beijing (CN); Wei WEI, Beijing (CN); Haijian MA, Beijing (CN)

(21) Appl. No.: 18/465,775

(22) Filed: Sep. 12, 2023

(30) Foreign Application Priority Data
Dec. 29, 2022 (CN) 202211713779.2

(51) Int. Cl. H02J 7/00

(52) U.S. Cl. CPC H02J 7/00712; H02J 7/00032

(57) ABSTRACT

A charging method includes obtaining a target charging current, determining a target value based on the target charging current, and configuring a target parameter of a charging strategy based on the target value. The target charging current is provided to a battery by an external power supply. The charging strategy controls charging of the battery by the external power supply.

### CROSS-REFERENCE TO RELATED APPLICATION

The present disclosure claims priority to Chinese Patent Application No. 202211713779.2, filed on Dec. 29, 2022, the entire content of which is incorporated herein by reference.

### TECHNICAL FIELD

The present disclosure relates to the charging technology field and, more particularly, to a charging method, device, charging circuit, electronic device, and storage medium.

### BACKGROUND

Users demand high battery charging performance when using an electronic device. Often, a fixed charging strategy is predetermined to charge a battery. A charging parameter related to the charging strategy is also fixed. However, a charging circuit has different states in different periods, and the environment of the charging circuit can change too. Thus, the charging performance can be affected. Charging the battery with the fixed and same parameters may not be an effective charging method for the battery.

### SUMMARY

Embodiments of the present disclosure provide a charging method. The method includes obtaining a target charging current, determining a target value based on the target charging current, and configuring a target parameter of a charging strategy based on the target value. The target charging current is provided to a battery by an external power supply. The charging strategy controls charging of the battery by the external power supply.

Embodiments of the present disclosure provide a charging device, including an acquisition module, a determination module, and a configuration module. The acquisition module is configured to obtain a target charging current. The target charging current is provided to a battery by an external power supply. The determination module is configured to determine a target value based on the target charging current. The configuration module is configured to configure a target parameter of a charging strategy based on the target value. The charging strategy controls charging of the battery by the external power supply.

Embodiments of the present disclosure provide an electronic device, including a battery and a charging chip. The charging chip is configured to obtain a target charging current, determine a target value based on the target charging current, and configure a target parameter of a charging strategy based on the target value. The target charging current is provided to a battery by an external power supply. The charging strategy controls charging of the battery by the external power supply.

### BRIEF DESCRIPTION OF THE DRAWINGS

FIG. 1 illustrates a schematic structural diagram of a charging circuit according to some embodiments of the present disclosure.

FIG. 2 illustrates a schematic structural diagram of a power supply circuit of an electronic device according to some embodiments of the present disclosure.

FIG. 3 illustrates a schematic flowchart of a charging method according to some embodiments of the present disclosure.

FIG. 4 illustrates a schematic detailed flowchart of step 301 according to some embodiments of the present disclosure.

FIG. 5 illustrates a schematic structural diagram of a charging circuit according to some embodiments of the present disclosure.

FIG. 6A illustrates a schematic diagram showing a curve of a target charging current in a pre-charging phase according to some embodiments of the present disclosure.

FIG. 6B illustrates a schematic diagram showing a curve of a battery voltage in a pre-charging phase according to some embodiments of the present disclosure.

FIG. 7A illustrates a schematic curve diagram showing changes in battery voltage and battery power in a charging process according to some embodiments of the present disclosure.

FIG. 7B illustrates a schematic curve diagram showing that a battery charging current changes with battery voltage in a charging process according to some embodiments of the present disclosure.

### DETAILED DESCRIPTION OF THE EMBODIMENTS

To make the objective, technical solution, and advantage of the present disclosure clear, the present disclosure is described in detail in connection with the accompanying drawings. The described embodiments cannot be considered to limit the present disclosure. All other embodiments obtained by those of ordinary skill in the art without creative efforts are within the scope of the present disclosure.

In the description below, “some embodiments” describe a subset of all possible embodiments. “some embodiments” can refer to a same subset or different subsets of all possible embodiments, which can be combined with each other when there is no conflict.

In embodiments of the present disclosure, terms of first, second, and third are used solely to distinguish similar objects and do not indicate any specific order. A specific order or sequence of first, second, and third can be interchanged to allow embodiments of the present disclosure to be implemented in an order different from the embodiments illustrated or described here.

Unless otherwise defined, all technical and scientific terms used in the present disclosure have the same meanings as commonly understood by those skilled in the art. The terms used in the present disclosure are only for the purpose of describing embodiments of the present disclosure and are not intended to limit the present disclosure.

To shorten a charging time, a rapid charging method of Flash Fast Charge (FFC) is introduced in the charging technology. The principle of FFC is Vcv (charging constant voltage threshold)=Vmax (battery charging voltage limit)+Vfloat (floating voltage generated by charging momentary high current). The charging method can be influenced by the chemical characteristics of lithium batteries. Thus, even though floating voltages of batteries of a same model can be affected by external factors such as charger capability, battery capacity, environment temperature, battery aging, and actual charging current. Therefore, the battery can be overly charged in certain conditions by using a fixed floating voltage value, which affects battery lifetime and accelerates battery aging. Thus, the battery capacity can be declined greatly. The battery can even be swollen to have safety issues, which can greatly affect the user experience. For example, when a 60 W cell phone is charged with a 60 W charger, and the battery capacity is over 90%, the actual charging current may not be large. When the floating voltage resistance of the cell phone battery is determined, the actual battery floating voltage may not be large. If the cell phone is charged according to the predetermined fixed floating voltage of 0.03V, the battery can be overly charged.

Based on this, embodiments of the present disclosure provide a charging method, device, charging circuit, electronic device, and computer-readable storage medium to enhance battery charging efficiency and safety. In some embodiments, each time when an adapter is connected to an electronic device (wired or wirelessly) for charging, the battery floating voltage value can be automatically determined and configured as a parameter value of the target parameter of a charging strategy for a current charging process. Thus, the electronic device can charge the battery based on the configured charging strategy. In different charging processes, values of the battery float voltage configured for the charging strategy can be different. In some other embodiments, each time when the adapter is connected to the electronic device (wired or wirelessly) for charging, a charging constant voltage threshold can be automatically determined and configured as a threshold in a constant voltage charging stage of the charging strategy in the current charging process. Thus, the electronic device can charge the battery based on the configured charging strategy. In different charging processes, the thresholds of the constant voltage charging stage configured for the charging strategy can be different.

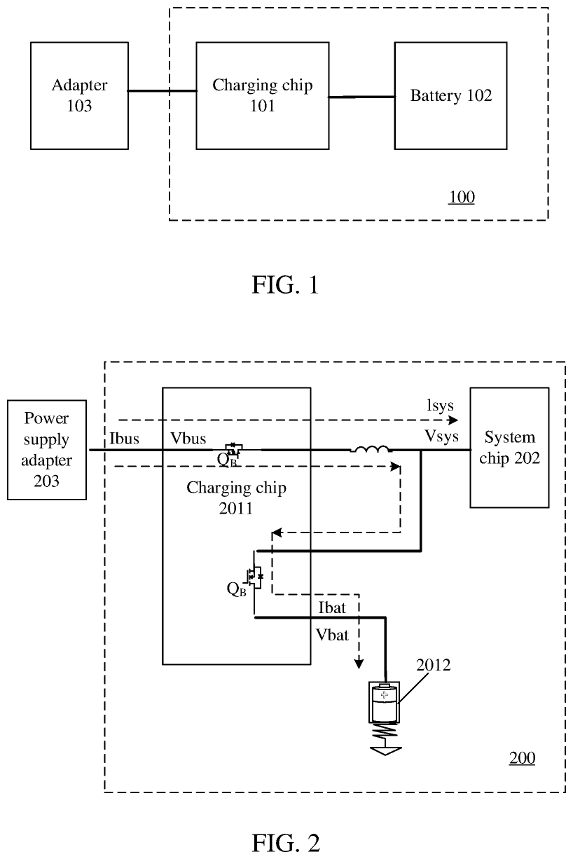

FIG. 1 illustrates a schematic structural diagram of a charging circuit 100 according to some embodiments of the present disclosure. As shown in FIG. 1, the charging circuit 100 includes a charging chip 101 and a battery 102 that are electrically connected. In some embodiments, if a power supply adapter 103 provides an external power supply, the charging chip 101 can charge the battery 102 according to the charging strategy.

The electronic device configured to implement the above charging method of embodiments of the present disclosure is described below. The electronic device of embodiments of the present disclosure can include the charging circuit 100. In some embodiments, the electronic device can include a power supply circuit. The power supply circuit can include the charging circuit. FIG. 2 illustrates a schematic structural diagram of a power supply circuit 200 of an electronic device according to some embodiments of the present disclosure. The power supply circuit 200 includes a charging circuit 201 and a system 202 that are electrically connected. The charging circuit 201 includes a charging chip 2011 and a battery 2012. In the power supply circuit 200, the battery 2012 can supply power to the system 202. If the power supply circuit 200 is connected to an external power supply through the power adapter 203, the external power supply can also supply power to the system 202. In some embodiments, the electronic device can be but is not limited to a terminal, a server, an electronic home device, and an electronic wearable device. The terminal can include a laptop, a tablet, a desktop computer, a smartphone, a dedicated messaging device, a portable gaming device, a smart speaker, a smartwatch, etc., which is not limited to these.

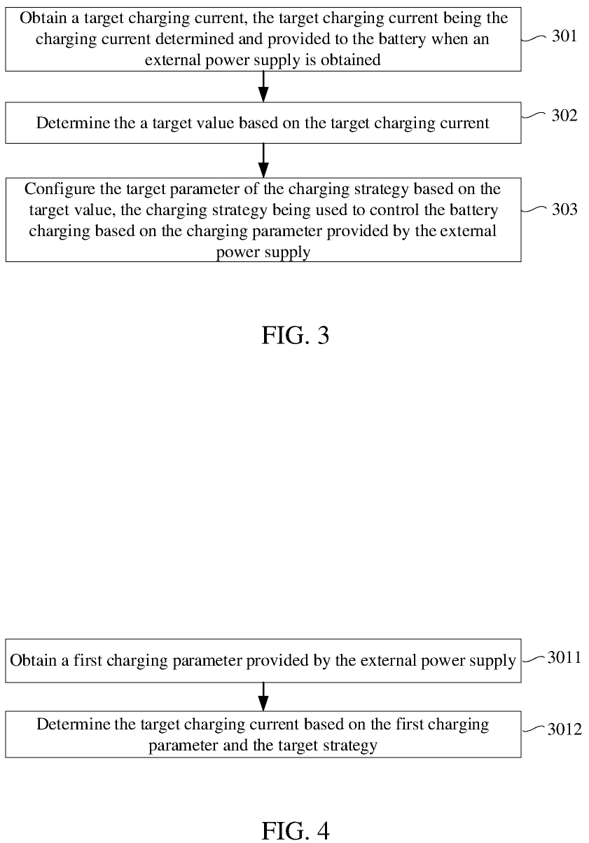

The charging method of embodiments of the present disclosure is described in connection with exemplary applications and implementations of the charging circuit of embodiments of the present disclosure. FIG. 3 illustrates a schematic flowchart of the charging method according to some embodiments of the present disclosure. The charging method is described in connection with the steps illustrated in FIG. 3.

At 301, a target charging current is obtained. The target charging current is the charging current determined and provided to the battery when an external power supply is obtained.

At 302, a target value is determined based on the target charging current.

At 303, the target parameter of the charging strategy is configured based on the target value. The charging strategy is used to control the battery charging based on the charging parameter provided by the external power supply.

In some embodiments, the target charging current can be the charging current (i.e., the charging current flowing to the battery) provided to the battery based on the current state of the battery and the charging strategy when the external power supply (i.e., adapter) is connected. The target charging current can be obtained on the charging path from the charging chip to the battery. The target value can be determined based on the target charging current. The target parameter of the charging strategy can be configured based on the target value. The battery can be charged based on the configured charging strategy and the charging parameter provided by the external power supply. That is, in the current charging process, the battery can be charged based on the configured charging strategy. In some other embodiments, in the current charging process, the battery can be charged based on the charging strategy when the external power supply (i.e., adapter) is connected. After the target value is determined, and the charging strategy is configured according to the target parameter, the battery can continue to be charged based on the configured charging strategy.

In some embodiments, the charging chip can obtain the target charging current. The target charging current can be the charging current determined and provided to the battery when the external power supply is obtained. The moment of obtaining the external power supply can be the moment when the charging chip and the external power supply are converted from a disconnected state to a connected state, for example, the moment when the power supply adapter is connected to the external power supply to cause the charging circuit to be connected to the external power supply. Thus, the external power supply can be but is not limited to a household alternating voltage and a mobile power supply. The target charging current can be the current flowing into the battery. For example, as shown in FIG. 2, the target charging current is Ibat.

In some embodiments, after obtaining the target charging current, the target value can be determined based on the target charging current, and the target parameter of the charging strategy can be configured based on the target value. The target parameter can be a specific charging parameter in the charging strategy for charging the battery, for example, a charging current, a charging voltage, or a condition parameter in the charging strategy. In some embodiments, the target parameter can be a threshold of charging current or a threshold of a charging voltage. The condition parameter can be the battery power for switching the charging phase. For example, when the battery power reaches 80%, the charging can be switched from the constant current charging phase to the constant voltage charging phase. The target parameter may not be limited here. In some embodiments, the target value can be assigned to the target parameter. That is, the value of the target parameter can be determined to be the target value.

In some embodiments, the charging chip can be configured to configure the target parameter of the charging strategy through the method of embodiments of the present disclosure each time after being connected to the external power supply. Then, the charging chip can be configured to charge the battery according to the charging strategy with the configured target parameter. In embodiments of the present disclosure, the target parameter of the charging strategy can be configured each time the battery is charging. Thus, the charging strategy each time the battery is charging can be ensured to be the effective charging method to improve the charging performance.

In some embodiments, the charging strategy can include at least the constant voltage charging stage. The target parameter can include a threshold of the constant voltage charging stage. As the battery power changes, the battery charging process can at least include one charging phase. The constant voltage charging phase can be one of the charging phase. For example, the at least one charging phase can include a pre-charging phase, a constant current charging phase, a constant voltage charging phase, and a trickle charging phase. The constant voltage charging stage of embodiments of the present disclosure can be one of the at least one charging phase.

In embodiments of the present disclosure, after the target value is determined, the threshold of the constant voltage charging phase in the charging strategy can be configured according to the target value. In some embodiments, the threshold of the constant voltage charging phase can be determined to be the target value. That is, the charging chip can be controlled to charge the battery with the corresponding charging strategy based on the charging parameter provided by the external power supply. In some embodiments, in the constant voltage charging phase, the battery can be charged with a constant voltage not exceeding the target value. In embodiments of the present disclosure, by configuring the threshold of the constant voltage charging phase each time the battery is charging, the charging efficiency can be ensured in a maximal range of avoiding overcharging.

In some embodiments, FIG. 4 illustrates a schematic detailed flowchart of step 301 according to some embodiments of the present disclosure. Step 301 includes the following steps.

At 3011, a first charging parameter provided by the external power supply is obtained.

At 3012, the target charging current is determined based on the first charging parameter and the target strategy.

In some embodiments, when the charging chip detects that the charging chip is connected to the external power supply, the charging chip can obtain the first charging parameter provided by the external power supply. As shown in FIG. 2, in embodiments of the present disclosure, the first charging parameter (Ibus) is the current of the external power supply flowing into the charging chip via the adapter. In some embodiments, the rated current of the external power supply can be used as the first charging parameter (Ibus). In some embodiments, the charging chip can obtain the parameter of the power supply adapter after being connected to the external power supply through the power supply adapter. The charging chip can obtain the rated current from the parameter of the power supply adapter and determine the first charging parameter (Ibus) according to the rated current. In some embodiments, the rated current can be directly used as the first charging parameter Ibus, or the actual current output by the power supply adapter can be used as the first charging parameter (Ibus).

Subsequently, based on the first charging parameter and the target strategy, the target charging current Ibat can be determined. In some embodiments, the target strategy can include determining the current value corresponding to the first charging parameter directly as the current value of the target charging current. In some embodiments, the target strategy can also include determining the target charging current based on the battery state. The battery state can include but is not limited to a plurality of pieces of state information such as the current capacity, the temperature, the aging level, and the internal resistance of the battery. In some embodiments, values of the plurality of pieces of state information of the battery can be obtained, and the target charging current can be determined according to the correspondence between the plurality of pieces of state information, the first charging parameter, and the target charging current. The correspondence can be predetermined. In some embodiments, the different state information can be normalized to a same data standard using coefficients. The target current can be determined according to the state information after being normalized in the same data standard and the correspondence. In some embodiments, weights can be set correspondingly for the plurality of pieces of state information. For example, state information with a greater impact on the target charging current can be assigned a bigger weight to accurately determine the target charging current based on the battery state.

After determining the target charging current, the target parameter of the charging strategy can be configured according to the method of embodiments of the present disclosure. Thus, the battery can be charged according to the charging strategy configured with the target parameter. In embodiments of the present disclosure, after the first charging parameter provided by the external power supply is obtained, the target charging current can be further determined based on the first charging parameter and the target strategy. Thus, the target charging current can be ensured to be accurate, and the configured target parameter can be further ensured to be accurate.

In some embodiments, step 302 can include determining the target value based on the target charging current and a calculation strategy.

In embodiments of the present disclosure, after obtaining the target charging current, the target value can be calculated in real-time based on the calculation strategy to ensure the target value obtained each time is accurate. In some embodiments, the calculation strategy can include charging the battery based on the target charging current with a time length to satisfying a target time length, obtaining a first voltage at a first moment, the first moment belonging to the target time length, and obtaining a second voltage at a second moment different the first moment. The second moment belongs to the target time length.

In some embodiments, after the charging chip is detected to be connected to the external power supply, the battery can be pre-charged with the target charging current for the target time length, and the first voltage at the first moment and the second voltage at the second moment can be obtained in the target time length. Then, the target value can be determined according to the first voltage and the second voltage. In some embodiments, the target charging current can include a first current and a second current. The charging chip can be configured to charge the battery periodically with the first current and the second current for the target time length. The first voltage and the second voltage can be a maximum voltage and a minimal voltage in a charging cycle within the target time length, respectively.

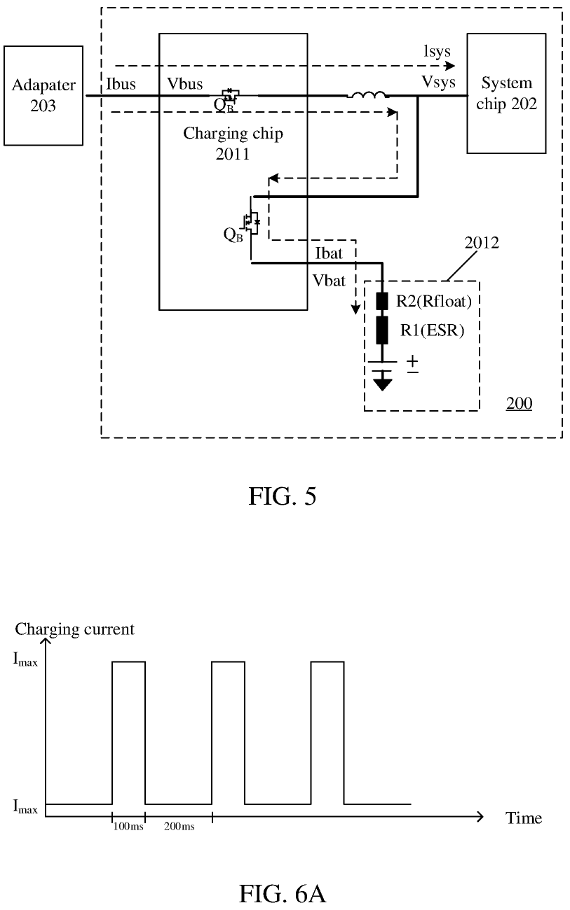

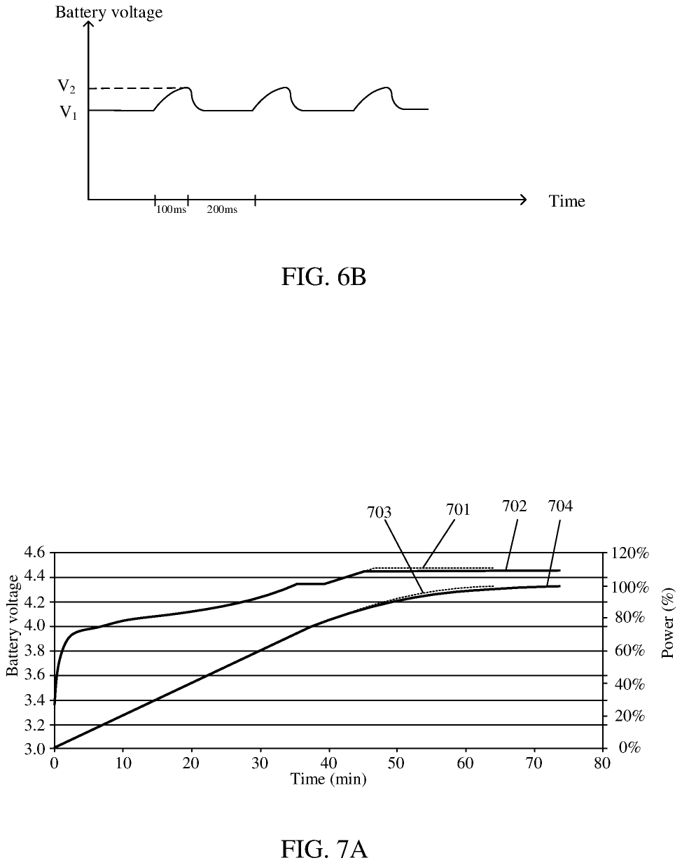

FIG. 5 illustrates a schematic structural diagram of a charging circuit according to some embodiments of the present disclosure. The power supply circuit shown in FIG. 2 can be equivalently illustrated in FIG. 5. That is, the battery can be equivalently represented as a series of equivalent resistance R1 (ESR), floating voltage resistance R2 (Rfloat), and a power supply Vdd. For example, FIG. 6A illustrates a schematic diagram showing a curve of the target charging current in a pre-charging phase according to some embodiments of the present disclosure. FIG. 6B illustrates a schematic diagram showing a curve of the battery voltage in the pre-charging phase according to some embodiments of the present disclosure. The target charging current includes a first current Imax and a second current Imin. During the pre-charging phase, the battery can be periodically charged with the first current Imax and the second current Imin. The first voltage V1 and the second voltage V2 at the first moment of the pre-charging phase can be obtained. Then, according to the first current Imax, the second current Imin, the first voltage V1, and the second voltage V2, the battery floating voltage resistance R_{float} can be calculated as R_{float}=|V₂−V₁|/|Iₘₐₓ−Iₘᵢₙ|.

Subsequently, the floating voltage can be determined according to the floating voltage resistance. In embodiments of the present disclosure, a product of the maximum charging current that is provided by the external power supply to the battery and the floating voltage resistance can be calculated. The product can be used as the floating voltage, that is, V_{float}=R_{float}*Iₘₐₓ. Then, the charging voltage threshold of the battery can be obtained, and a sum of the charging voltage threshold Vmax and the floating voltage V_{float} can be used as the target value. The threshold of the constant voltage charging phase in the charging strategy can be determined to be the target value. That is, the threshold of the constant voltage charging phase is V_{cv}=Vₘₐₓ+V_{float}.

In some embodiments, during the battery charging process according to the charging strategy, if the charging process enters the constant voltage charging phase, the battery can be charged with a constant voltage lower than or equal to the threshold V_{cv} to avoid damage to the battery due to the excessively high charging voltage.

In some embodiments, step 302 can also include obtaining the target value based on the target charging current and a configuration table.

The configuration table can be pre-determined and include a correspondence between the target charging current and the target value. In some embodiments, the configuration table can be queried based on the target charging current to obtain the target value corresponding to the target charging current. The correspondence in the configuration table can be set as the correspondence between the current range and the target value. In some embodiments, the current range in which the target charging current is can be determined first. Then, the corresponding target value can be determined according to the corresponding current range. By configuring the configuration table, the calculation load of the charging chip can be reduced, and the target value can be determined more efficiently.

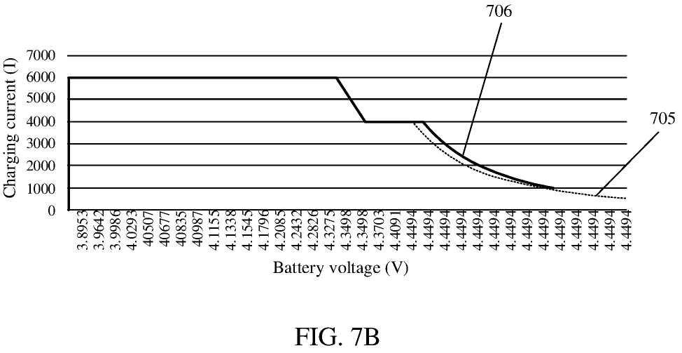

In some embodiments, for example, FIG. 7A illustrates a schematic curve diagram showing changes in battery voltage and battery power in a charging process according to some embodiments of the present disclosure. FIG. 7B illustrates a schematic curve diagram showing that a battery charging current changes with the battery voltage in the charging process according to some embodiments of the present disclosure. As shown in FIG. 7A and FIG. 7B, dashed lines (701, 703, and 705) represent charging curves of the battery according to the charging method of embodiments of the present disclosure. Solid lines (702, 704, and 706) represent charging curves of the battery according to the charging methods of the related technologies. Dashed line 701 and solid line 702 represent curves showing the battery voltage changing over time. Dashed line 703 and solid line 704 represent curves showing the battery capacity changing over time. Dashed line 705 and solid line 706 represent curves showing the charging current changing over time. As shown in FIG. 7A, in the constant voltage charging phase in the charging process using the charging method of embodiments of the present disclosure, the charging voltage is higher, the battery power can be quickly increased, which increases the battery charging speed. As shown in FIG. 7B, charging using the charging method of embodiments of the present disclosure can make the switching process from the constant current charging phase to the constant voltage charging phase smoother. The charging current in the constant voltage charging phase can be lower. Thus, the charging safety can be higher while the power is increased quickly.

In some embodiments, the target charging current can be obtained. The target charging current can be the charging current provided to the battery when the external power supply is obtained. The target value can be determined based on the target charging current. The target parameter of the charging strategy can be configured based on the target value. The charging strategy can be used to control to charge the battery based on the charging parameter provided by the external power supply. By determining the corresponding target parameter of charging measurement each time obtaining the power provided by the external power supply, that is, each time before charging, the charging strategy can adapt to batteries of different states in real-time. Thus, the charging efficiency of the battery can be effectively increased, and the charging safety can be improved.

In some embodiments, the charging device can be implemented using software and/or a combination of software and hardware components. The charging device can include a first display module, a detection module, a determination module, and a second display module. These modules are logical modules, which may be implemented by software components, or by a combination of software and hardware components to deliver certain functionality. These modules can be further combined or divided arbitrarily according to functions implemented. The functions of the modules are described below.

In some embodiments, the software modules of the charging device can include an acquisition module, a determination module, and a configuration module.

The acquisition module can be configured to obtain the target charging current. The target charging current can be the current provided to the battery when the external power supply is obtained.

The determination module can be configured to determine the target value based on the target charging current.

The configuration module can be configured to configure the target parameter of the charging strategy based on the target value. The charging strategy can be used to control to charge the battery based on the charging parameter provided by the external power supply.

In some embodiments, the charging strategy can at least include the constant voltage charging phase. The target parameter can be the threshold of the constant voltage charging phase.

In some embodiments, obtaining the target charging current can include obtaining the first charging parameter provided by the external power supply, and determining the target charging current based on the first charging parameter and the target strategy.

In some embodiments, determining the target value based on the target charging current can include obtaining the target value based on the target charging current and the configuration table.

In some embodiments, determining the target value based on the target charging current can include determining the target value based on the target charging current and a calculation strategy.

In some embodiments, the calculation strategy can include charging the battery with the target charging current for a time length satisfying the target time length, obtaining the first voltage at the first moment, and obtaining the second voltage at the second moment different from the first moment. The first moment can be within the target time length. The second moment can be within the target time length.

In some other embodiments, the charging device can be implemented using hardware. For example, the charging device of embodiments of the present disclosure can include a processor in a form of a hardware decoding processor, which can be programmed to execute the charging method of embodiments of the present disclosure. For example, the processor can include one or more of an Application-Specific Integrated Circuit (ASIC), a DSP, a Programmable Logic Device (PLD), a Complex Programmable Logic Device (CPLD), a Field-Programmable Gate Array (FPGA), or another electronic element.

The description of the device of embodiments of the present disclosure can be similar to the description of method embodiments above and has similar beneficial effects, which are not repeated here.

As shown in FIG. 2, embodiments of the present disclosure provide the charging circuit, including the battery and the charging chip. The charging chip can be configured to obtain the target charging current, determine the target value based on the target charging current, and configure the target parameter of the charging strategy based on the target value. The target charging current can be the charging current provided to the battery when the external power supply is obtained. The charging strategy can be used to control to charge the battery based on the charging parameter provided by the external power supply. Moreover, each time the threshold of the constant voltage charging phase can be calculated accurately to avoid overcharging to extend the battery lifetime.

Embodiments of the present disclosure further provide a computer program product or computer program. The computer program product or the computer program can include computer instructions. The computer instructions can be stored in a computer-readable storage medium. The processor of the computer can read the computer instructions from the computer-readable storage medium. The processor can execute the computer instructions to cause the computer to perform the charging method of embodiments of the present disclosure.

Embodiments of the present disclosure provide a computer-readable storage medium storing the executable instructions. When the executable instructions are executed by the processor, the processor can be configured to perform the charging method of embodiments of the present disclosure.

In some embodiments, the computer-readable storage medium can include a FRAM, a ROM, a PROM, an EPROM, an EEPROM, a flash memory, a magnetic storage, optical discs, CD-ROMs, or a device including one of the storages, or any combination thereof.

In some embodiments, the executable instructions can include programs, software, software modules, scripts, or codes, which can be programmed by any programming language (including compiled or interpreted languages, and declarative or procedural languages). The instructions can be deployed in various forms, including a standalone program or as a module, assembly, a sub-program, or other units suitable for use in a computation environment.

For example, the executable instructions can or may not correspond to files in a file system. The executable instructions can be stored as a part of a file storing other programs or data, for example, in one or more scripts stored in Hyper Text Markup Language (HTML) files, in a single file dedicated to the discussed program, or in a plurality of collaborative files (e.g., files storing one or more modules, sub-programs, or code sections).

For example, the executable instructions can be deployed on a computer device for execution, on a plurality of computer devices in one location for execution, or on a plurality of computer devices distributed across a plurality of locations and interconnected through a communication network.

In summary, the battery charging efficiency and safety can be improved through embodiments of the present disclosure.

The above are only embodiments of the present disclosure and is not intended to limit the scope of protection of the present disclosure. Modifications, equivalent replacements, and improvements made within the spirit and scope of the present disclosure are within the scope of the present disclosure.

What is claimed is:

1. A charging method comprising:
obtaining a target charging current, wherein the target charging current is provided to a battery by an external power supply;
determining a target value based on the target charging current; and
configuring a target parameter of a charging strategy based on the target value, wherein the charging strategy controls charging of the battery by the external power supply.

2. The method of claim 1, wherein the charging strategy at least includes a constant voltage charging phase, and the target parameter is a threshold of the constant voltage charging phase.

3. The method of claim 1, wherein obtaining the target charging current includes:
obtaining a first charging parameter provided by the external power supply; and
determining the target charging current based on the first charging parameter and a target strategy.

4. The method of claim 1, wherein determining the target value based on the target charging current includes:
obtaining the target value based on the target charging current and a configuration table.

5. The method of claim 1, wherein determining the target value based on the target charging current includes:
determining the target value based on the target charging current and a calculation strategy.

6. The method of claim 1, wherein the calculation strategy includes:
charging the battery for a time length satisfying a target time length based on the target charging current;
obtaining a first voltage at a first moment in the target time length; and
obtaining a second voltage at a second moment different from the first moment in the target time length.

7. A charging device comprising:
an acquisition module configured to obtain a target charging current, wherein the target charging current is provided to a battery by an external power supply;
a determination module configured to determine a target value based on the target charging current; and
a configuration module configured to configure a target parameter of a charging strategy based on the target value, wherein the charging strategy controls charging of the battery by the external power supply.

8. The device of claim 7, wherein the charging strategy at least includes a constant voltage charging phase, and the target parameter is a threshold of the constant voltage charging phase.

9. The device of claim 7, wherein the acquisition module is further configured to:
obtain a first charging parameter provided by the external power supply; and
determine the target charging current based on the first charging parameter and a target strategy.

10. The device of claim 7, wherein the determination module is further configured to:
obtain the target value based on the target charging current and a configuration table.

11. The device of claim 7, wherein the determination module is further configured to:
determine the target value based on the target charging current and a calculation strategy.

12. The device of claim 7, wherein the calculation strategy includes:
charging the battery for a time length satisfying a target time length based on the target charging current;
obtaining a first voltage at a first moment in the target time length; and
obtaining a second voltage at a second moment different from the first moment in the target time length.

13. An electronic device comprising:
a battery; and
a charging chip configured to:
obtain a target charging current, wherein the target charging current is provided to a battery by an external power supply;
determine a target value based on the target charging current; and
configure a target parameter of a charging strategy based on the target value, wherein the charging strategy controls charging of the battery by the external power supply.

14. The device of claim 13, wherein the charging strategy at least includes a constant voltage charging phase, and the target parameter is a threshold of the constant voltage charging phase.

15. The device of claim 13, wherein the charging chip is further configured to:
obtain a first charging parameter provided by the external power supply; and
determine the target charging current based on the first charging parameter and a target strategy.

16. The device of claim 13, wherein the charging chip is further configured to:
obtain the target value based on the target charging current and a configuration table.

17. The device of claim 13, wherein the charging chip is further configured to:
determine the target value based on the target charging current and a calculation strategy.

18. The device of claim 13, wherein the calculation strategy includes:
charging the battery for a time length satisfying a target time length based on the target charging current;
obtaining a first voltage at a first moment in the target time length; and
obtaining a second voltage at a second moment different from the first moment in the target time length.
